(19) United States
(12) Patent Application Publication
(10) Pub. No.: US 2022/0396851 A1
(43) Pub. Date: Dec. 15, 2022

(54) METHOD FOR PRODUCING COPPER METAL FROM COPPER CONCENTRATES WITHOUT GENERATING WASTE

(71) Applicant: UNIVERSIDAD DE CONCEPCION, Concepcion (CL)

(72) Inventors: Igor WILKOMIRSKY FUICA, Concepcion (CL); Fernando Antonio PARADA LUNA, Concepcion (CL); Eduardo BALLADARES VARELA, Concepcion (CL); Roberto PARRA FIGUEROA, Concepcion (CL)

(21) Appl. No.: 17/755,992

(22) PCT Filed: Oct. 21, 2020
(86) PCT No.: PCT/CL2020/050139

§ 371 Date: May 13, 2022

(30) Foreign Application Priority Data
Nov. 13, 2019 (CL) 3246-2019

(51) Int. Cl. C22B 15/00; C22B 1/10; C22B 1/26; C22B 3/14; C22B 5/12; C22B 11/00; C22B 34/34

(52) U.S. Cl. CPC C22B 15/0028; C22B 1/10; C22B 1/26; C22B 3/14; C22B 5/12; C22B 11/04; C22B 15/0015; C22B 15/006; C22B 34/34

(57) ABSTRACT

A method for producing copper metal from copper concentrates without generating waste by: (a) oxidizing copper concentrate; (b) cleaning and cooling the gases; (c) feeding to a reduction reactor; (d) cleaning the gases; (e) discharging hot powders and calcines into water; (f) performing magnetic separation; (g) thickening and filtering the magnetic fraction; (h) floating silica and inert materials; (i) thickening and filtering the silica and inert materials; (j) thickening and filtering the final concentrate containing the copper metal and noble metals; (k) smelting the final concentrate of copper and noble metals; and (l) recirculating ground smelt slag to a roasting reactor.

### TECHNICAL AREA

The technology is oriented to the mining area, more particularly, corresponds to a process to produce copper metal from copper concentrates without generating waste.

### PRIOR ART

For more than 100 years, blister copper production technology has remained virtually stagnant, and while it has allowed the production of blister copper at a competitive price until 1 or 2 decades ago, its intrinsic limitations due to the inevitable leakage of gases with sulfur dioxide (SO₂) and the formation of a large quantity of slags, make it necessary to have radically different alternatives not only in terms of capital costs and operation of the plants, but also in their potential degree of automation, zero emissions of gases into the environment, generation of slags and recovery of other metals contained in the copper concentrates, that is, a “zero waste” process for the 21st century.

Although some more advanced fusion/conversion technologies have emerged such as the Outokumpu-Kennecott, Mitsubishi and Ausmelt, they all generate between 0,8 to 1,2 tons of slag per ton of blister copper generated, and the global capture of sulfur as SO₂ even with the best technology does not exceed 98%. In addition, only copper and noble metals are recovered from the copper concentrate, discarding others of commercial value contained in the concentrates such as molybdenum, zinc, and iron.

Chile, which is the largest copper producer in the world, has only made a significant contribution to the copper smelting technology with the Lieutenant

Converter (CT), which is already more than half a century old, and there is no new technology in development that exceeds the limitations of the current ones.

Fugitive emissions of gases containing SO₂ into the environment, as well as the generation of slag in all copper concentrate smelting processes are two widespread problems. The slag contains between 2 to 10% copper and must be reprocessed, and still end up with 0.5-0.8% copper and other metals of commercial value that represent an environmental liability of great magnitude. In Chile it is estimated that there are about 50 million tons of slag in the dumps, and that they also contain about 2 million tons of copper, already unrecoverable.

On the other hand, the new Chilean environmental legislation capturing 95% of SO₂ (D.S. No,28/2013, of the MMA, published on Dec. 12, 2013) which entered into force in 2019 and future of 98% can make several of the Chilean smelters technically and economically unviable, which would bring Chile back to a country that only produces concentrates, which predicts a future complex for the seven Chilean copper smelters.

There is no combined process to date, being the only technology developed by the company AMAX Inc. of the United States⁽¹⁾ in which copper concentrates are roasted (oxidized) with air at 880° C. up to low 1% sulfur and then the calcine is pelletized with coal or coke to reduce it and smelt at 1200-1300° C. in an open hearth, cupola or rotary kiln. As can be seen, in this patent the calcine must be smelted to reduce it, forming a large amount of slag with 6 to 12% of copper, since nothing of the iron is previously eliminated. The process was tested on a demonstration scale and not industrially applied, possibly due to this limitation. ⁽¹⁾ “H. P. Rajcevic, W. R. Opie and D. C. Cusanelli, “Production of blister Copper from calcined Copper-iron concentrates”, U.S. Pat. 4,072,507, (Feb. 7, 1978).

Reductive roasting from hematite (Fe₂O₃) to magnetite (Fe₃O₄) has been commercially used for several decades⁽²⁾⁽³⁾ for iron minerals containing low-grade ⁽²⁾ Wade H. H. and Schulz, N. F., “Magnetic roasting of iron ones”, Min. Engr., No. 11, p. 1161-1165, (1960).⁽³⁾ G. Uwadiale, “Magnetizing roasting of iron ores”, Min. Processes and Extr. Metallurgy Review, Vol. 11, Nos. 1 and 2, p. 68-70, (1992). grade hematite that cannot be concentrated, so that by transforming the hematite into magnetite it can be easily concentrated in magnetic form, so that it is an established technology for hematitic iron minerals.

Based on this background, there is still a need to develop new technologies to produce copper metal from copper concentrates that are efficient and environmentally friendly.

### BRIEF DESCRIPTION OF THE DRAWINGS

FIG. 1: Schematic of the process for producing copper metal from copper concentrates.

FIG. 2: Graph of Standard free energy of reaction of mineral compounds.

FIG. 3: Quaternary phase stability diagram Cu—Fe—S—O at 800° C. (Cu/Fe=2/1).

FIG. 4: Diagram of the standard free energies of reduction reaction with carbon monoxide and with hydrogen.

FIG. 5: Diagram of Quaternary phase stability Cu—Fe—C—O at 700° C.

FIG. 6: Process diagram of a technological alternative with a fluidized bed reactor.

FIG. 7: Diagram of Phase stability Cu—Fe—H₂—O₂ at 700° C.

FIG. 8: Process diagram of a technological alternative using hydrogen.

### DISCLOSURE OF THE INVENTION

The present technology corresponds to a process for producing copper metal from copper concentrates without generating waste. Unlike conventional casting processes, in this invention the melting temperature of the materials is not reached, since it is operated at a temperature at which reactions occur between solids and gases, and not between molten materials.

The process comprises two main and two secondary stages. In the first main stage, the copper concentrate is oxidized (roasted) with air in an environmentally closed system that virtually removes the entire sulfur as SO₂ to produce sulfuric acid, leaving a virtually sulfur-free oxidized calcine where the copper, iron and other metals are transformed to their respective more stable oxides.

In the second main stage, the oxidized calcine is reduced to copper metal and magnetite in a second reactor at 500-950° C. using coal, carbon monoxide or hydrogen as reducers, to finally separate the copper from the iron in magnetic form and then the sterile one (mainly silica), in order to obtain a final product of copper metal and noble metals to be melted and electrolytically refined in conventional form, also recovering the iron as a concentrate of magnetite, silica, zinc and molybdenum (if any in the initial concentrate), all as commercial products.

In this way, and unlike the conventional smelting processes currently in use, no slag is generated, nor fugitive gases with SO_{2,} therefore all the metals contained in the fed copper concentrate are recovered.

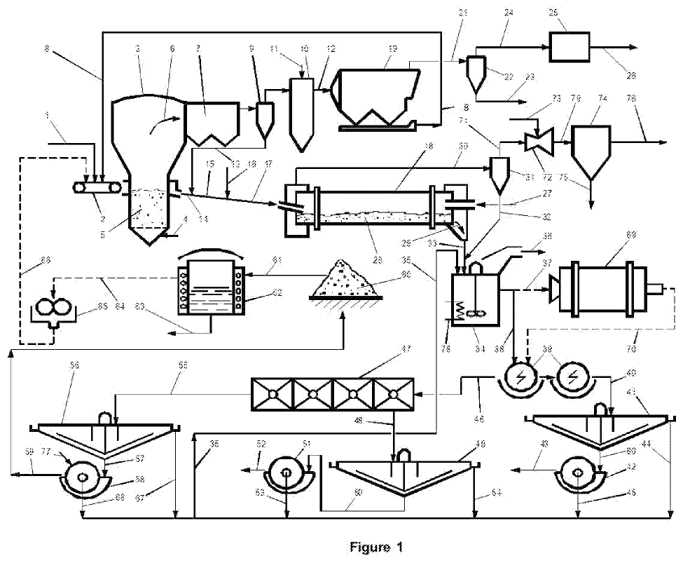

For a better understanding of this invention, a detailed description of the process will be made below, referring to FIGS. 1-8.

In FIG. 1, a dry or wet copper concentrate 1 with up to 12% humidity is fed by a conventional system 2 to a conventional fluidized bed roasting reactor 3, which operates between 650 to 900° C., preferably between 700 to 850° C. using air 4 or oxygen-enriched air so that the following reactions occur in the fluidized bed 5 for a typical copper concentrate containing chalcopyrite (CuFeS₂), covelite (CuS), chalcocite (Cu₂S) and pyrite (FeS₂):

CuFeS₂₍ₛ₎+3.250_{2(g}=CuO(s)+0.5Fe₂O₃₍ₛ₎+2SO_{2(g)} (1)

CuS₍ₛ₎+1.50_{2(g)}=CuO₍ₛ₎+SO₂₍ₛ₎ (2)

Cu₂S₍ₛ₎+2O_{2(g)}=2CuO₍ₛ₎+SO_{2(g)} (3)

FeS₂₍ₛ₎+2.75O_{2(g)}=0.5Fe₂O₃₍ₛ₎+2SO_{2(g)} (4)

CuO₍ₛ₎+Fe₂O₃₍ₛ₎=CuO.Fe₂O₃₍ₛ₎ (5)

The extent to which reaction (5) of cupric ferrite formation (CuO.Fe₂O₃) occurs is variable and depends on the reaction temperature and time. At 800° C., about 15% of the copper contained in the concentrate forms copper ferrite.

The reaction time in reactor 3 ranges between 2 to 12 h, preferably between 4 to 8 h, using air or oxygen-enriched air between 21 to 100% by volume of oxygen and an excess of air (oxygen) employed with respect to the stoichiometric required by reactions (1) to (4), which ranges from 0.001 to 200%, preferably between 50 and 100% excess.

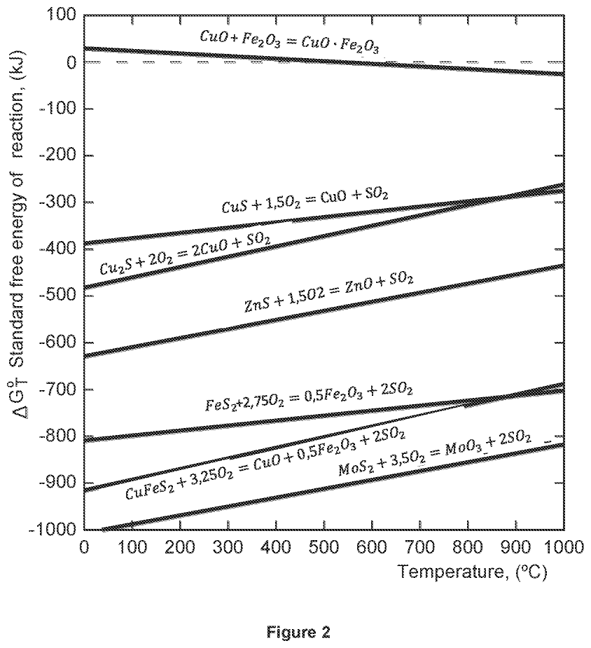

All these reactions are spontaneous with negative values (by convention) of their standard reaction free energies as seen in FIG. 2, where the values of the standard reaction free energies with oxygen of mineral compounds generally present in copper concentrates as a function of the reaction temperature are plotted.

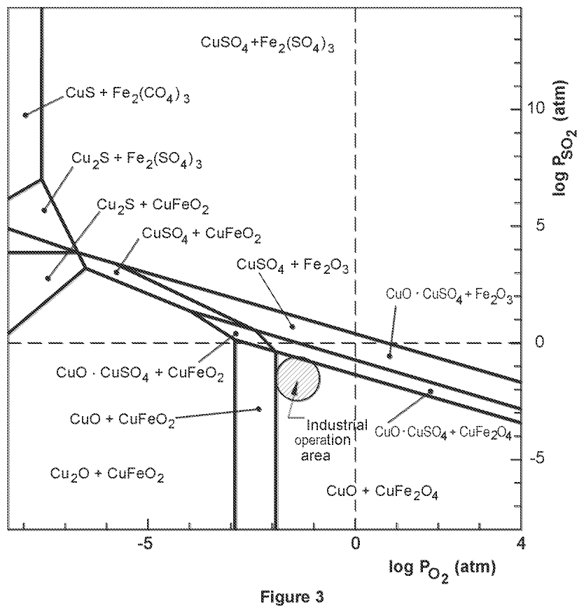

FIG. 3 shows the diagram of quaternary phase stability Cu—Fe—S—O at 800° C. under chemical equilibrium conditions as a function on the partial pressures of oxygen (air) and sulfur dioxide (SO₂) for the reactions that occur in the fluidized bed 5, where the stability area of the copper and iron compounds formed in the calcine can be observed under the operating conditions of an industrial reactor.

If the concentrate contains zinc, for example, as sphalerite (ZnS), it is oxidized to ZnO according to the reaction:

ZnS₍ₛ₎+1.5O_{2(g)}═ZnO₍ₛ₎+SO_{2(g)} (6)

If the concentrate contains molybdenum as molybdenite (MoS₂), it is oxidized to trioxide (MoO₃) which is volatile at about 650° C. and then condenses with the powders of the electrostatic precipitator, from where it can be recovered by leaching the powders in conventional form, for example, with a solution of ammonium hydroxide to then precipitate the ammonium molybdate, this being a commercial product.

The oxidation reaction occurring in the roasting reactor is as follows:

MoS₂₍ₛ₎+3.5O_{2(g)}=MoO_{3(g)}+2SO_{2(g)} (7)

All these reactions are exothermic, that is, they generate heat so that the reactor 3 does not require additional heat, furthermore, its hot gases 6 pass to a conventional boiler 7 to recover some of the heat as high-pressure steam for industrial use.

The sulfur contained in the copper concentrate 1 fed to the reactor 3, and where over 99% of it is oxidized to sulfur dioxide (SO₂), leaves the reactor with the gases 6, which after cooling to 400-450° C. in the boiler 7 are cleaned in conventional cyclones 9, and then again cooled to 300-320° C. in a conventional evaporative chamber 10 using sprayed water 11. The exhaust gases 12 end up being cleaned in a conventional electrostatic precipitator 19. The powder 8 of the electrostatic precipitator can be returned to the reactor 3 and the cleaned gases 21 are washed in a conventional gas washer 22.

If the initial copper concentrate 1 contains arsenic, it can be precipitated from the effluent 23 of the gas washer 22 in conventional form, for example, as ferric arsenate (scorodite). The clean gases 24 eventually go to a conventional acid plant 25 to produce sulfuric acid 26 for sale.

The oxidized calcine containing essentially cupric oxide (CuO), hematite (Fe₂O₃), cupric ferrite (CuO.Fe₂O₃), zinc oxide (ZnO), silica (SiO₂) and other sterile such as silicates, hot discharge 14 of the roasting reactor 3 and together with the powders 13 generated in the boiler 7 and in the cyclones 9, 15 are joined to feed 17 the calcine reduction reactor 18, adding a reduction agent 16 such as coal, coke coal or carbon monoxide (CO) in an amount between 0.001 to 200% excess of the stoichiometric required to carry out reactions (8) to (11), preferably between 0.001 to 100% excess. Where the carbon monoxide (CO) gas is generated externally in a conventional carburetor and removing the sulfur, if any, in a conventional way in a limestone desulphurizer, (CaCO₃). Optionally, it can be carried out using gas containing hydrogen between 10 to 20% by volume, at a temperature between 600 to 950° C., preferably between 700 to 800° C.

The reduction reactor 18 may be a conventional one such as a rotary kiln, in which the charge 28 of calcines and reducer generate carbon monoxide (CO) to reduce the oxides of copper, iron and zinc (if any) according to the following reactions:

CuO₍ₛ₎+CO_{(g)}=Cu₍ₛ₎+CO_{2(g)} (8)

3Fe₂O₃₍ₛ₎+CO_{(g)}=2Fe₃O₄₍ₛ₎+CO_{2(g)} (9)

3CuO.Fe₂O₃+4CO_{(g)}=3Cu₍ₛ₎+2Fe₃O₄₍ₛ₎+4CO_{2(g)} (10)

ZnO₍ₛ₎+CO_{(g)}=Zn_{(g)}+Co_{2(g)} (11)

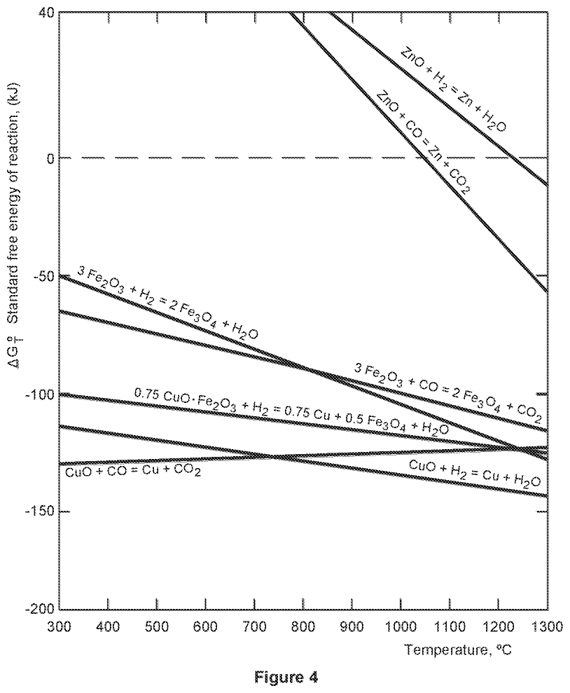

FIG. 4 shows the diagram of the standard free energies of the reduction reactions with carbon monoxide (CO) as a function of temperature for reactions (8) to (11). It is observed that all reactions have a negative value of the standard free energy of reaction (spontaneous) between 300-1300° C., however, the reduction of zinc oxide (ZnO) to gaseous metal zinc with carbon monoxide (CO) requires a temperature higher than 1000° C.

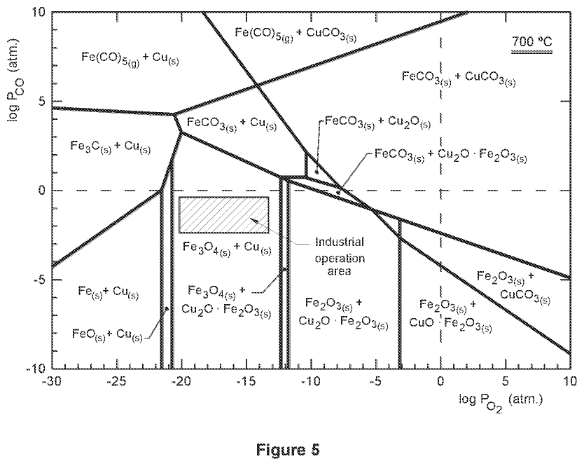

FIG. 5 shows the diagram of quaternary phase stability Cu—Fe—C—O at 700° C. as a function of the partial pressure of the reducer (CO) and the partial pressure of the oxygen in the gas phase, indicating the operating area of an industrial reduction reactor in which the metallic copper (Cu) and the ferrous-ferric oxide (magnetite) of iron (Fe₃O₄) are stable.

All reduction reactions (8) to (11) are exothermic, so that the reduction reactor 18 does not require additional heat to operate. The operating temperature of this reactor ranges between 500 to 950° C., preferably between 700 to 800° C. with a reaction time between 2 to 6 h. If necessary, conventional fuel such as natural gas or oil 27 can be added to the reduction reactor 18.

The exhaust gases 30 from the reduction reactor 18 are cleaned in one or more conventional cyclones 31. The reduced calcine in the reactor 18 discharges 29 together with powders 32 separated into conventional cyclones 31 and the mixture 33 of calcines 29 and powders 32 discharges directly into a stirred pond with conventional water 34 operating at a liquid temperature between 20 to 60° C., where the violent thermal shock of the hot calcine and cold water results in the fracturing and release of any metallic copper particles trapped in the magnetite (generated by the reduction of the cupric ferrite, according to reaction (9)). The steam generated is continuously removed 36 from the stirred pond, which maintains the temperature of the water in the desired range by a conventional heat exchanger 78. If required, the resulting pulp 37 may be wet ground in a conventional rod or ball mill 69 to complete the release of the copper metal from the magnetite.

If the copper concentrate contains zinc, to reduce zinc oxide to gaseous metal zinc it is required to operate the reduction reactor with a zone at temperature over 1000° C. to produce the reduction reaction (11). In such a case, the gaseous zinc contained in the gas 71 generated in the reduction reactor 18 according to reaction (11) is re-oxidized with cold air 73 in a conventional gas mixer such as a Venturi 72, where the gaseous zinc is oxidized according to the reaction:

2Zn_{(g)}+O_{2(g)}=2ZnO₍ₛ₎ (12)

The gases 79 containing fine zinc oxide are cleaned in a conventional equipment 74 such as a bag filter to recover zinc oxide for sale 75. The clean gases 76 can be vented into the atmosphere.

The pulp of calcine and water generated 38 in the stirred pond 34 or generated in that of the mill 69 is brought 70 to a magnetic separation system in conventional wet drums 39 of one or more stages and with a field density between 18,000 to 20,000 Gauss in which the magnetite (Fe₃O₄), which is strongly ferromagnetic, is separated from the non-magnetic rest formed by particles of metallic copper, silica and other inert materials such as silicates and the noble metals that could accompany the copper concentrate. In this way, a high magnetite law concentrate 40 is obtained which is brought to a conventional thickening step 41. The low flow of the thickener 80 is brought to a conventional filtering step 42 and the final check of magnetite concentrate 43 is sold. Both the clear water 44 of the thickener 41 and the filtrate 45 of the filter 42 are recirculated 35 to the stirred pond 34.

The non-magnetic fraction 46 containing the copper and other non-magnetic materials is carried to a flotation step 47, wherein silica and other inerts such as silicates present in conventional form are floated, for example, at pH between to 10.5 employing conventional collectors and foams, such as dodecylammonium acetate and potassium nitrate (KNO₃) and with a flotation time of 5 to 8 minutes to generate a pulp 48, which is thickened in a conventional thickener 49. The low flow 50 thereof is brought to a conventional filtering step 51 to generate a concentrate of silica and other sterile 52 for sale, for example, as copper flux.

The final tail (pulp) 55 generated in the flotation step 47 contains virtually all of the copper and noble metals such as fine metallic particles, which are thickened in a conventional thickener 56, and the low flow 57 is brought to a conventional filtering step 58. The copper metal check is washed with fresh water 77 in the filter, and the final check of copper and noble metals 59 is brought to storage 60 from where it is loaded 61 to a conventional smelting furnace 62 such as an electric induction furnace, to thus have copper metal 63 equivalent to the blister copper together with the noble metals dissolved therein, for subsequent conventional electrolytic refining.

Both the clear water 67 and 54 of the thickeners 49 and 56 and the filtrate 53 and 68 of the filters 51 and 58 are recirculated to the process 35, to the pond 34.

Any slag that may be formed 64 in the smelting stage 62 is cooled and ground in a conventional milling equipment 65 and recirculated 66 to the roasting reactor 3 to recover the copper contained therein. If zinc has not been reduced, it will be contained in this slag 64 as oxide (ZnO) which can be recovered by leaching the slag in conventional form, for example, with a dilute solution of sulfuric acid and then electrodepositing the zinc therefrom.

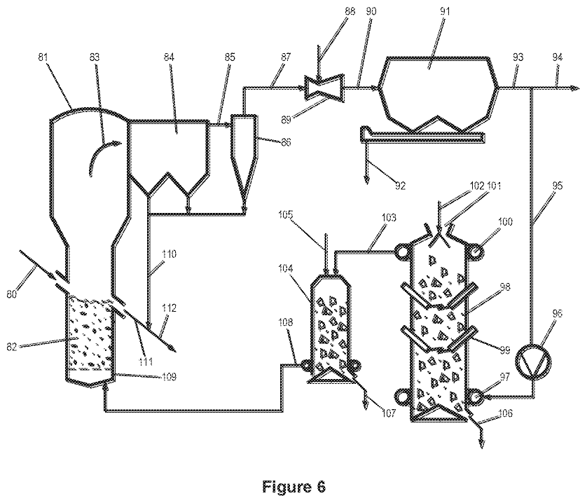

The step of reducing the oxidized calcines 15 generated in the reactor 3 can also be carried out in a gas fluidized bed reactor containing carbon monoxide (CO) generated externally in a carburetor. The schematic diagram of this technological alternative is shown in FIG. 6.

In this technological alternative, the oxidized calcine 80 coming from the roasting reactor is fed to a conventional fluidized bed reactor 81, in which in the reaction bed 82 the reactions described above Nos. (8) to (11) occur. The reaction gases and the entrained solid 83 pass to a conventional heat recovery boiler 84 to lower the gas temperature to 350-400° C. and recover heat as process steam. The solid collected goes to process 110. The gases 85 are then cleaned in one or more hot cyclones 86 where most of the solid entrained by the gases is separated and this is joined with the separated solid in the boiler 84 to bring it to process 110 together with the calcine 111 discharging from the reactor 81. The mixture 112 of hot calcine 111 and powders 110 discharges into a stirred pond with water, just like the pond 34 described in FIG. 1. The rest of the calcine process is equal to that described above.

The hot gases 87, over 300° C., are cooled with cold air 88 in a conventional gas mixer 89 such as in Venturi to oxidize and condense zinc oxide (ZnO) according to reaction (12). The gases containing zinc oxide are taken 90 to a conventional bag filter 91 where zinc oxide (ZnO) 92 is recovered for commercialization. The exhaust gases 93 of the bag filter 91, a part is discarded 94 into the atmosphere to maintain the oxygen balance in the system. The remainder 95 is compressed with a conventional compressor 96 and brought to a conventional carburizing equipment or carburetor 98 fed with metallurgical coke coal 102, which is fed to the upper part 101 of the carburetor 98, which operates at 700-800° C. to generate the CO formation reaction (Bouduard reaction) according to:

C₍ₛ₎+CO₂₍ₛ₎=2CO_{(g)} (13)

This reaction is endothermic and requires heat which is supplied by arc electrodes 99 or other conventional means. The gas containing oxygen, (O₂), nitrogen (N₂) and carbon dioxide (CO₂) enters the lower part 97 of the carburetor 98 and exits its upper part 100 with virtually only carbon monoxide (CO) and nitrogen (N₂), since oxygen reacts with the coke coal to produce carbon monoxide (CO) according to the reaction:

2C₍ₛ₎+O_{2(g)}=2CO_{(g)} (14)

The ashes from the coke coal 106 discharges through the lower part of the carburizing reactor 98.

The hot gas 103 exiting the upper part 100 of the carburetor 98 is brought to a sulfur capture reactor or desulphurizer 104 in the event that the coke coal contains sulfur, which would contaminate the calcine 112 generated. The desulphurizer is fed with limestone (CaCO₃) 105, which over 700° C. reacts with the gaseous sulfur generated in the carburetor 98 according to:

2CaCO₃₍ₛ₎+S_{2(g)}=2CaS₍ₛ₎+2CO_{2(g)}+O_{2(g)} (15)

The oxygen generated oxidizes the CO of the gas to CO₂, but because the sulfur present in the coke coal 102 does not always exceed 0.5%, the reaction (15) occurs to a very limited extent. Discharge 107 from desulphurizer 104 can be discarded.

The clean gas with carbon monoxide (CO) and a small amount of CO₂ and free of sulfur 108 is injected into the lower part 109 of the fluidized bed reduction reactor 81 to reduce the oxidized calcine according to what is explained above.

In addition to this alternative, the carbon monoxide (CO) reducing gas can be replaced by hydrogen (H₂). The advantage of using hydrogen (H₂) as a reducer is its generation external to the plant and that it can be injected directly into the reactor by mixing it with an inert gas such as nitrogen, since the reactions are pure and very violent, so that it can be diluted to 10-20% by volume. In addition, only water is generated as a product of the reduction reactions, which can be reused. Reactions that occur with hydrogen are as follows:

CuO₍ₛ₎+H_{2(g)}=Cu₍ₛ₎+H₂O_{(g)} (16)

3Fe₂O₃₍ₛ₎+H_{2(g)}=2Fe₃O₄₍ₛ₎+H₂O_{(g)} (17)

3CuO.Fe₂O₃₍ₛ₎+4H_{2(g)}=3Cu₍ₛ₎+2Fe₃O₄₍ₛ₎+4H₂O_{(g)} (18)

ZnO₍ₛ₎+H_{2(g)}=Zn_{(g)}+H₂O_{(g)} (19)

As can be seen in FIG. 4, the reduction of oxidized copper and iron calcines with hydrogen is possible throughout the temperature range considered, however, the reduction of zinc oxide requires a temperature over 1200° C., which is above the melting point of some phases present, so that if the copper concentrate contains zinc, the zinc oxide formed will end up as such together with the copper metal, from where it can be recovered from the slag by smelting copper and noble metals. Zinc oxide is readily soluble in dilute sulfuric acid, as indicated above.

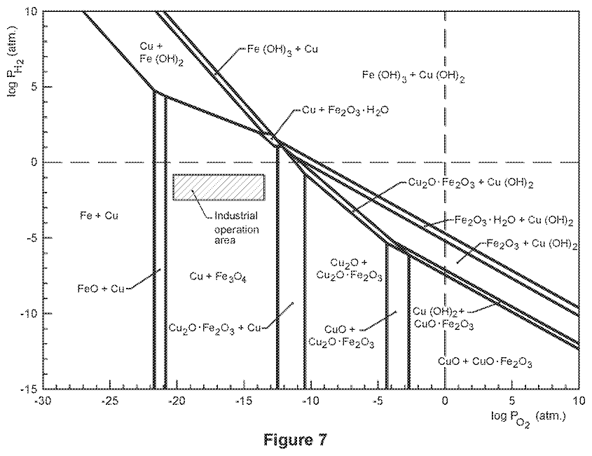

FIG. 7 shows the diagram of phase stability Cu—Fe—H₂—O₂ at 700° C. as a function of the partial pressure of hydrogen (H₂) and partial pressure of oxygen (O₂), indicating the stability area of the stable phases of copper metal and magnetite (Fe₃O₄).

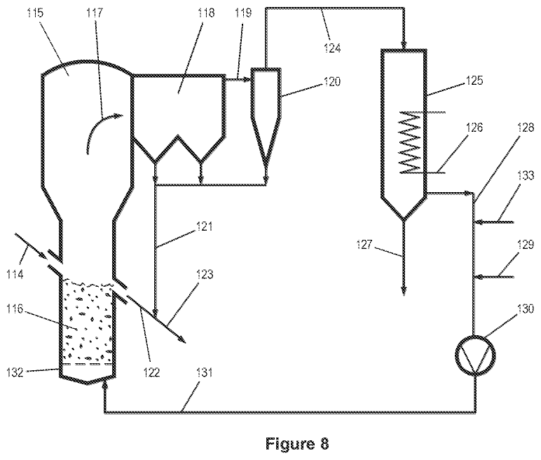

The process diagram of this technological alternative is shown in FIG. 8. The oxidized calcine 114 coming from the oxidizing roasting reactor is continuously fed to a conventional fluidized bed reactor 115, in which in its bed 116 the reduction reactions with hydrogen (H₂) N°s (16) to (19) occur at a temperature between 400 to 900° C., preferably between 600 to 800° C. with a reaction time of 0.5 to 12 h, preferably between 4 to 6 h, and which is fluidized with a gas containing between 1 to 90% by volume of hydrogen, preferably between 10 to 20% by volume and the rest of the nitrogen gas (N₂) or other inert gas. The reaction time of the solid in the bed 116 ranges from 2 to 8 h, preferably between 4 and 6 h.

The hot gases 117 also entraining solid particles are cooled to 350-400° C. in a conventional boiler 118 generating steam for industrial use and the gases 119 are then cleaned in one or more conventional hot cyclones 120. The clean gas 124 is then cooled in a conventional condenser 125 cooled by water 126 where it condenses the water 127 generated in reactions (16) to (18), which can be used as industrial water.

More fresh hydrogen (H₂) 133 and nitrogen (N₂) 129 are added to the outlet gas 128 of the condenser 125, if necessary, and compressed with a conventional compressor 130 and injected 131 into the bottom 132 of the fluidized bed reactor 115. In this technological option there is no emission of gases to the environment and the gas is continuously recirculated in the process and the only liquid product is recoverable water.

The powders 121 separated in the boiler 118 and cyclones 120 are joined with the calcine 122 and discharge 123 to a pond equal to the pond 34 described in FIG. 1. The rest of the process is equal to that described in FIG. 1 for reduced calcines.

### APPLICATION EXAMPLE

A copper concentrate with the chemical composition indicated in Table 1 and mineralogical of Table 2 was toasted in a continuous fluidized laboratory bed reactor at 800° C. (±10° C.) with a mean reaction time of 4 h at a feed rate of 5 kg/h and an excess of 100% of the air over the stoichiometric required by reactions (1) to (5). The particle size of the concentrate was 80%-100 mesh.

TABLE 1
Chemical composition of the copper concentrate used

| Element | Cu | Fe | S | SiO₂ | Others |
|---|---|---|---|---|---|
| % | 28.2 | 22.3 | 34.1 | 8.9 | 6.5 |

TABLE 2
Mineralogical composition of the copper concentrate used

| | Chalcopyrite | Chalcocite | Covellite | Bornite | Pyrite | Silica | Others |
|---|---|---|---|---|---|---|---|
| Compound | (CuFeS₂) | (Cu₂S) | (CuS) | (Cu₅FeS₄) | (FeS₂) | (SiO₂) | — |
| % | 19.9 | 24.3 | 1.0 | 3.2 | 31.2 | 8.9 | 9.8 |

The calcine along with the collected powders was cooled to 20° C. and analyzed chemically and mineralogically. The composition of this is shown in Tables 3 and 4.

TABLE 3
Chemical composition of the obtained calcine

| Element | Cu | Fe | S | SiO₂ | Others |
|---|---|---|---|---|---|
| % | 32.4 | 24.6 | 0.31 | 9.9 | 31.8 |

TABLE 4
Mineralogical composition of the obtained calcine

| | Cuprite | Hematite | Copper ferrite | Silica | Others |
|---|---|---|---|---|---|
| Element | (CuO) | Fe₂O₃ | (CuO•Fe₂O₃) | SiO₂ | — |
| % | 41.6 | 24.1 | 17.2 | 12.8 | 3.3 |

In the roasting step, 99.3% of the sulfur contained in the initial concentrate was removed to the SO₂ form. The composition of the reactor exhaust gas was 12.5 to 13% by volume of SO₂.

The calcine was then continuously reduced in a fluidized laboratory bed furnace by employing a mixture of CO+CO₂ in CO/(CO+CO₂)=0.5 to 800° C. for a mean reaction time of 2 h, feeding at a rate of 4 kg/h, and employing 20% of excess CO over the stoichiometric required by reactions (8) to (10).

The calcine was cooled directly in water to 30° C. and analyzed chemically and mineralogically. The results are seen in Table 5.

TABLE 5
Chemical composition of reduced calcine

| | Metallic | | | | |
|---|---|---|---|---|---|
| | copper | Magnetite | Total Sulfur | Silica | Others |
| Element | (Cu) | (Fe₃O₄) | (S) | (SiO₂) | — |
| % | 48.7 | 34.2 | 0.03 | 14.8 | 0.3 |

The calcine pulp with 25% solid was magnetically concentrated in a magnetic laboratory drum system in four stages with 400 Gauss/cm each, portraying the intermediate tails generated (in each stage) in three stages. The final magnetite concentrate contained 94.2% of magnetite (Fe₃O₄), 4% of silica (SiO₂) and 0.8% of others, with 0.1% of copper trapped.

The final tail (copper concentrate) contained 74.1% of metallic copper and 24.7% of silica, which was floated in three cleaning stages using 0.25 g/l of dodecylammonium and 0.05 g/l of potassium nitrate at pH 10 and removing 90.2% of the silica and other silicates and generating a concentrate of 92.9% of silica and 0.08% of copper. The final tail contained the metallic copper, with a law of 98.9% of copper, 0.8% of silica and 0.8% of magnetite, which was melted in an electric furnace at 1200° C. to have an equivalent to the blister copper. The overall recovery of copper from concentrate to final copper metal was 98.7%.

1. A process for producing copper metal from copper concentrates without generating waste comprising at least the following steps:
a. conducting an oxidation reaction by feeding a dry, or wet copper concentrate up to 12% of humidity, to a fluidized bed roasting reactor at 650-900° C. using air or oxygen-enriched air between 21 to 100% by volume of oxygen and an excess of oxygen with respect to a the required stoichiometric between 0.001 to 200%, and with a reaction time of 2-12 h;
b. conducting cleaning and cooling steps by cooling gases generated in the roasting reactor to 400-450° C. in a boiler and cleaning in conventional cyclones and then cooling to 300-320° C. in an evaporative chamber, cleaning outlet gases in an electrostatic precipitator, wherein powder of the precipitator is returned to the roasting reactor and clean gases are washed in a gas washer, and finally sent to an acid plant to produce sulfuric acid;
c. feeding to a reduction reactor hot discharge oxidized calcine from the roasting reactor and together with powders generated in the boiler and in the cyclones, are joined and fed to the reduction reactor, adding a reduction agent in an amount equal to or up to 200% excess of the stoichiometric, operating at 500-950° C. with a reaction time between 2 to 6 h, using coal, coke coal or carbon monoxide with an excess between 0.001 to 200% of the stoichiometric required for the reduction reactions;
d. cleaning exhaust gases from the reduction reactor in one or more conventional cyclones;
e. discharging calcines and hot powders into water by having reduced calcine in the reactor together with the powders separated into cyclones, discharged and mixed directly in a pond with stirred water operating at a liquid temperature between 20 to 60° C., where the fracturing and release of any metallic copper particles trapped in the magnetite occurs, where the generated steam is removed to maintain the water temperature, and where a the pulp is wet ground in a conventional mill to complete the release of the metallic copper from the magnetite;
f. conducting magnetic separation by having the pulp of calcine and water generated in the stirred pond or of the mill brought to a magnetic separation system in conventional wet drums of one or more stages and with a field density between 18,000 to 20,000 Gauss in which the magnetite is separated from the non-magnetic rest, obtaining a high magnetite law concentrate;
g. thickening and filtering the magnetic fraction by having the magnetite concentrate is sent to a conventional thickening step, wherein the low flow of the thickener is fed to a conventional filtering step to obtain the final check of magnetite concentrate; and wherein clear water of the thickener as filtering of the filter is recirculated to the stirred pond;
h. conducting flotation of the silica and inerts by having the non-magnetic fraction containing the copper and other non-magnetic materials is sent to a flotation step, where the silica and inerts are floated as silicates at pH between 10 to 10.5 employing conventional collectors and foams with a flotation time of 5 to 8 minutes to generate a pulp;
i. conducting thickening and filtration of silica and inerts by having the pulp thickened in a conventional thickener, wherein the low flow is brought to a filtering step to generate a sterile silica concentrate;
j. conducting thickening and filtration of the final concentrate containing the copper metal and noble metals by having the final pulp generated in the flotation step is thickened in a conventional thickener and the low flow is sent to a conventional filtering step, and wherein the metallic copper check is washed with fresh water in the filter, and the final check of copper and noble metals is brought to stockpile;
k. smelting of the final concentrate of copper and noble metals by loading the stockpile to a conventional smelting furnace in order to obtain metallic copper together with the noble metals dissolved therein, for subsequent conventional electrolytic refining;
l. recirculating the ground smelting slag to the roasting reactor by having the slag formed in the smelting stage cooled and ground in a conventional milling equipment and recirculated to the roasting reactor to recover the copper contained therein.

2. The process for producing copper metal from copper concentrates without generating waste according to claim 1, wherein, the roasting reactor operates at 700 to 850⁰C.

3. The process for producing copper metal from copper concentrates without generating waste according to claim 1, wherein in the roasting reactor the reaction time is from 4 to 8 h.

4. The process for producing copper metal from copper concentrates without generating waste according to claim 1, wherein excess air in the roasting reactor ranges between 50 and 100%.

5. The process for producing copper metal from copper concentrates without generating waste according to claim 1, wherein molybdenum present in the copper concentrate is recovered from the powders of the electrostatic precipitator of the oxidizing roasting stage by leaching the powders with a solution of ammonium hydroxide, in conventional form.

6. The process for producing copper metal from copper concentrates without generating waste according to claim 1, wherein in the reduction reactor the reducing agent is coke coal or carbon monoxide.

7. The process for producing copper metal from copper concentrates without generating waste according to claim 1, wherein in the reduction reactor the reducing agent is preferably fed between 0.001 to 100% excess.

8. The process for producing copper metal from copper concentrates without generating waste according to claim 1, wherein the reduction reactor is a rotary kiln.

9. The process for producing copper metal from copper concentrates without generating waste according to claim 1, wherein the reduction reactor operates at 700 to 800° C.

10. The process for producing copper metal from copper concentrates without generating waste according to claim 1, wherein the copper concentrate contains zinc and the reduction reactor operates in a zone at temperature over 1000° C. to produce the reduction reaction.

11. The process for producing copper metal from copper concentrates without generating waste according to claim 1 wherein gaseous zinc generated in the reduction reactor is re-oxidized with cold air in a gas mixer to generate zinc oxide.

12. The process for producing copper metal from copper concentrates without generating waste according to claim 1, wherein the reduction stage is carried out with carbon monoxide gas generated externally in a conventional carburetor and removing any sulfur in conventional form in a limestone desulfurizer.

13. The process for producing copper metal from copper concentrates without generating waste according to claim 1, wherein the reduction step is carried out using gas containing hydrogen between 10 to 20% volume, at a temperature between 600 to 950° C.

14. The process for producing copper metal from copper concentrates without generating waste according to claim 11, wherein gases containing zinc oxide are cleaned in a bag filter to recover zinc oxide and the clean gases are vented to the atmosphere.

15. The process for producing copper metal from copper concentrates without generating waste according to claim 1, wherein in the flotation stage, collectors and foaming agents are used.

16. The process for producing copper metal from copper concentrates without generating waste according to claim 1, wherein in the smelting stage of the final concentrate of copper and noble metals, the furnace is of electric induction.

17. The process for producing copper metal from copper concentrates without generating waste according to claim 1, wherein the oxidation reaction step is carried out in a gas fluidized bed reactor containing carbon monoxide generated externally in a carburetor.

18. The process for producing copper metal from copper concentrates without generating waste according to claim 1, wherein the oxidized calcine from the roasting reactor is fed to a fluidized bed reactor, where the reaction gases and the entrained solid pass to a heat recovery boiler to lower the temperature of the gas to 350-400° C. and recover heat as process steam; where the gases are cleaned in one or more hot cyclones where most of the solid entrained by the gases is separated and this is joined with the separated solid in the boiler to bring it to process together with the calcine that discharges from the reactor and where the mixture of hot calcine and powders discharges in a stirred pond with water.

19. The process for producing copper metal from copper concentrates without generating waste according to claim 17, wherein the hot gases, over 300° C., are cooled with cold air in a gas mixer to oxidize and condense the zinc oxide and the gases containing the zinc oxide are taken to a bag filter where the zinc oxide is recovered; wherein the output gases of the bag filter, a part is discarded the atmosphere and the rest is compressed with a compressor and brought to a carburizing equipment fed with metallurgical coke coal, which is fed to the carburetor operating at 700-800° C. and where the heat is supplied by arc electrodes; the hot gas exiting the carburetor is brought to a sulfur capture reactor or desulfurizer; where the desulfurizer is fed with limestone; the clean gas with carbon monoxide and a small amount of CO₂ and sulfur-free is injected into the fluidized bed reduction reactor to reduce oxidized calcine.

20. The process for producing copper metal from copper concentrates without generating waste according to claim 1, wherein hydrogen is used as a reducing gas.

21. The process for producing metallic copper from copper concentrates without generating waste according to claim 1, wherein the oxidized calcine from the oxidizing roasting reactor is fed to a fluidized bed reactor, in which in its bed the reduction reactions with hydrogen at a temperature between 400 to 900° C. with a reaction time of 0.5 to 12 h occur, and then it is fluidized with a gas containing between 1 to 90% by volume of hydrogen and the rest of the gas nitrogen or other inert gas; and where the hot gases also entraining solid particles are cooled to 350-400° C. in a conventional boiler generating steam for industrial use, and the gases are then cleaned in one or more conventional hot cyclones; where the clean gas is cooled in a condenser; and where in the outlet gas of the condenser more fresh hydrogen and nitrogen are added, and it is compressed with a conventional compressor and injected at the lower part of the fluidized bed reactor and where the powders separated in the boiler and cyclones are joined with the calcine and discharged to a pond.

22. The process for producing copper metal from copper concentrates without generating waste according to claim 21, wherein the reduction reactions with hydrogen preferably occur between 600 to 800° C. and with a reaction time between 4 to 6 h.
